(19) United States
(12) Patent Application Publication
(10) Pub. No.: US 2025/0034442 A1
(43) Pub. Date: Jan. 30, 2025

(54) POLYURETHANE-BASED COMPOSITION

(71) Applicant: Bostik SA, COLOMBES (FR)

(72) Inventors: Saïda MULLER-SELLAK, VENETTE (FR); Federico SANZ, VENETTE (FR); Cyrielle IBANEZ, Saint-Remy-Les-Chevreuse (FR); Lorenzo YEE, Saint-Remy-Les-Chevreuse (FR)

(21) Appl. No.: 18/716,967

(22) PCT Filed: Dec. 15, 2022
(86) PCT No.: PCT/FR2022/052372

§ 371 Date: Jun. 6, 2024

(30) Foreign Application Priority Data
Dec. 17, 2021 (FR) 2113824

(51) Int. Cl. C09J 175/08; C08G 18/10; C08G 18/32; C08G 18/40; C08G 18/48; C08G 18/62; C08G 18/66; C08G 18/67; C08G 18/76; C08K 3/26; C08K 7/28; C09J 11/04

(52) U.S. Cl. CPC C09J 175/08; C08G 18/10; C08G 18/3206; C08G 18/4063; C08G 18/4825; C08G 18/6204; C08G 18/6674; C08G 18/6755; C08G 18/7664; C08K 3/26; C08K 7/28; C09J 11/04; C08K 2003/265

(57) ABSTRACT

A composition comprises an —NCO component and an —OH component. The —NCO component comprises at least one polyurethane having at least two NCO end groups and optionally a polyisocyanate compound comprising at least one polyisocyanate P comprising at least three isocyanate functions NCO. The —OH component comprises a polybutadiene polyol P1 comprising at least two hydroxyl functions, said polyol P1 having a number-average molecular weight ranging from 1000 g/mol to 15 000 g/mol; a polyol P2 chosen from diols, triols, or mixtures thereof, a polyol P3 having a hydroxyl functionality of greater than or equal to 2, said polyol P3 being chosen from the group consisting of polyether polyols, polyols of natural origin, polyester polyols, and mixtures thereof, and at least one filler, the total content of filler(s) being greater than or equal to 30% by weight relative to the total weight of said —OH component.

### FIELD OF THE INVENTION

The present invention relates to a polyurethane-based composition.

The invention also relates to the use of said composition for the adhesive bonding of materials in the field of structural assembly such as the automotive, aeronautical and/or construction sectors.

### TECHNOLOGICAL BACKGROUND

Epoxy resins are now widely used in industry, and in advanced technologies such as the automotive or electronics sectors. They are often used in the form of 2 main components: an epoxy resin and a hardener. It is the polymerization (or crosslinking) reaction between the two components, once mixed, that gives the epoxy resins their strength and adhesion. They are resins with very effective structural properties and can be used in many fields.

However, existing epoxy resins have the drawback of being rigid and brittle at low temperatures. Yet in structural assembly in general, there is a need for sealant-type adhesives that have structural properties but also flexible properties in order to withstand movements and deformations, all over a wide temperature spectrum. For example, in the automotive field, it is important to have adhesives which can be used and have suitable properties over a range, for example, extending from −60° C. to 50° C. Specifically, adhesive bonding near engines can be subjected to low temperatures in countries where the outside temperature is negative, and on the other hand subjected to high temperatures in hot countries. A similar situation is found in aeronautics where the temperature variation between take-off and the temperature at 1000 feet varies considerably.

There is therefore a need for new compositions which make it possible to at least partially overcome these drawbacks.

More particularly, there is a need for new compositions which possess structural and flexible properties over a broad temperature spectrum, even at low temperatures such as, for example, at −60° C.

There is also a need for new compositions which possess structural properties over a broad temperature spectrum, while maintaining good adhesive and rheological properties such as, for example, the absence of flow.

### DESCRIPTION OF THE INVENTION

### Composition

The present invention relates to a composition comprising:
an —NCO component comprising:
   A) at least one polyurethane having at least two NCO end groups;
   B) optionally a polyisocyanate compound comprising at least one polyisocyanate P comprising at least three isocyanate functions NCO;
an —OH component comprising:
   a polybutadiene polyol P1 comprising at least two hydroxyl functions, said polyol P1 having a number-average molecular weight ranging from 1000 g/mol to 15 000 g/mol;
   a polyol P2 chosen from diols, triols or mixtures thereof, said polyol P2 having a number-average molecular weight or number-average molar mass ranging from 60 to 500 g/mol;
   a polyol P3 having a hydroxyl functionality of greater than or equal to 2, said polyol P3 being chosen from the group consisting of polyether polyols, polyols of natural origin, polyester polyols, and mixtures thereof, said polyol P3 having a number-average molecular weight ranging from 800 to 5000 g/mol;
   at least one filler, the total content of filler(s) being greater than or equal to 30% by weight relative to the total weight of said-OH component.

### —NCO COMPONENT

The composition according to the invention comprises an —NCO component comprising:
A) at least one polyurethane having at least two NCO end groups;
B) optionally a polyisocyanate compound comprising at least one polyisocyanate P comprising at least three isocyanate functions NCO;

### A)NCO-Terminated Polyurethane

The polyurethane A) having at least two NCO end groups can be obtained by a polyaddition reaction:
of a composition comprising at least one polyisocyanate;
of a composition comprising at least one polyol.

### Polyisocyanate

The polyisocyanate may be chosen from monomeric polyisocyanates, polymeric polyisocyanates and mixtures thereof.

In the context of the invention, and unless otherwise mentioned, the term “polymeric polyisocyanate” covers oligomeric polyisocyanates.

The monomeric polyisocyanates may be chosen from diisocyanates, triisocyanates and mixtures thereof. The diisocyanates can be chosen from the group consisting of isophorone diisocyanate (IPDI), hexamethylene diisocyanate (HDI), heptane diisocyanate, octane diisocyanate, nonane diisocyanate, decane diisocyanate, undecane diisocyanate, dodecane diisocyanate, dicyclohexylmethane-4,4′-diisocyanate (4,4′-HMDI), norbornane diisocyanate, norbornene diisocyanate, cyclohexane-1,4-diisocyanate (CHDI), methylcyclohexane diisocyanate, ethylcyclohexane diisocyanate, propylcyclohexane diisocyanate, methyldiethylcyclohexane diisocyanate, cyclohexanedimethylene diisocyanate, 2-methylpentane-1,5-diisocyanate (MPDI), 2,4,4-trimethylhexane-1,6-diisocyanate, 2,2,4-trimethylhexane-1,6-diisocyanate (TMDI), 4-(isocyanatomethyl) octane-1,8-diisocyanate (TIN), 2,5-bis(isocyanatomethyl) bicyclo[2.2.1]heptane (2,5-NBDI), 2,6-bis(isocyanatomethyl) bicyclo[2.2.1]heptane (2,6-NBDI), 1,3-bis(isocyanatomethyl) cyclohexane (1,3-H6-XDI), 1,4-bis(isocyanatomethyl) cyclohexane (1,4-H6-XDI), xylylene diisocyanate (XDI) (especially m-xylylene diisocyanate (m-XDI)), toluene diisocyanate (in particular toluene-2,4-diisocyanate (2,4-TDI) and/or toluene-2,6-diisocyanate (2,6-TDI)), diphenylmethane diisocyanate (in particular diphenylmethane-4,4′-diisocyanate (4,4′-MDI) and/or diphenylmethane-2,4′-diisocyanate (2,4′-MDI)), tetramethylxylylene diisocyanate (TMXDI) (in particular tetramethyl-meta-xylylene diisocyanate), an HDI allophanate, for example having the following formula (Y):

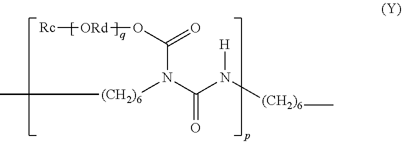

in which p is an integer ranging from 1 to 2, q is an integer ranging from 0 to 9 and preferably 2 to 5, R_{c} represents a saturated or unsaturated, cyclic or acyclic, linear or branched hydrocarbon-based chain comprising from 1 to 20 carbon atoms, preferably from 6 to 14 carbon atoms, R_{d} represents a linear or branched divalent alkylene group containing from 2 to 4 carbon atoms, and preferably a divalent propylene group;
and mixtures thereof.

The triisocyanates may be chosen from isocyanurates, biurets, and adducts of diisocyanates and triols.

The polymeric polyisocyanates may be chosen from polymeric MDI (PMDI, or alternatively polymethylene polyphenylene polyisocyanate).

The polymeric MDIs typically contain a mixture of monomeric MDI with MDI oligomers. For example, the polymeric MDIs may have the following general formula:

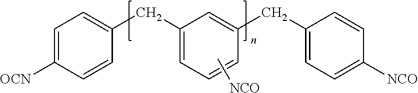

wherein n can vary from 1 to 8, and in particular from 1 to 5.

The polymeric MDIs may have an average NCO functionality of greater than 2, preferably ranging from 2.3 to 3.5, and even more preferentially from 2.7 to 3.0.

The term “average NCO functionality of a mixture” is understood to mean the average number of NCO functions per mole of mixture.

Polymeric MDIs are sold in particular by Dow Chemical Company, such as for example Voranate PAPI®20, PAPI®27, M229 and by BorsodChem, such as Ongronat® 2510.

According to a preferred embodiment, the polyurethane A) is obtained from a composition comprising at least one polyisocyanate, said composition having an average NCO functionality ranging from 2.3 to 3.5, more preferably from 2.7 to 3.0.

According to a preferred embodiment, the polyurethane A) is obtained from polymeric MDI.

### Polyol

The polyol which can be used to prepare the abovementioned polyurethane A) may be chosen from polyether polyols, polyester polyols, and mixtures thereof.

The polyol may have a number-average molecular weight ranging from 200 g/mol to 20 000 g/mol, preferably from 400 g/mol to 18 000 g/mol, even more preferentially from 400 g/mol to 12 000 g/mol, advantageously from 400 g/mol to 8000 g/mol, even more advantageously from 400 to 4000 g/mol.

The polyol may in particular be chosen from those for which the number-average molecular weight Mn is less than or equal to 4000 g/mol, advantageously strictly less than 2000 g/mol, and more preferentially those for which the number-average molecular weight Mn ranges from 400 to 1500 g/mol.

The number-average molecular weight of the polyols can be calculated from the hydroxyl number (OHN), expressed in mg KOH/g, and from the functionality of the polyol or determined by methods well known to a person skilled in the art, for example by size exclusion chromatography (SEC) with PEG (polyethylene glycol) standard.

The polyol that can be used to prepare the polyurethane A) may have a hydroxyl functionality greater than or equal to 2, preferably greater than or equal to 3.

The polyether polyols may be chosen from polyoxyalkylene polyols, the (saturated) linear or branched alkylene part of which comprises from 2 to 4 carbon atoms, and preferably from 2 to 3 carbon atoms.

The polyether polyols are preferably chosen from polyoxyalkylene diols or polyoxyalkylene triols, and better still from polyoxyalkylene triols, the linear or branched alkylene part of which comprises from 1 to 4 carbon atoms, preferably from 2 to 3 carbon atoms.

As examples of polyoxyalkylene diols or triols which can be used according to the invention, mention may for example be made of polyoxypropylene diol or triol (also denoted by polypropylene glycol (PPG)diol or triol), polyoxyethylene diol or triol (also denoted by polyethylene glycol (PEG)diol or triol) and polyoxybutylene glycols (also denoted by polybutylene glycol (PBG)diol or triol), copolymers or terpolymers of PPG/PEG/PBG diol or triol, polytetrahydrofuran (PolyTHF), polytetramethylene glycols (PTMG), and mixtures thereof.

Preferably, the polyether polyols are chosen from polyoxypropylene triols. The abovementioned polyether polyols can be prepared conventionally and are widely available commercially. They may, for example, be obtained by polymerization of the corresponding alkylene oxide in the presence of a catalyst.

Mention may be made, as example of polyether triols, of the polyoxypropylene triol sold under the name “Voranol CP3355” by Dow, with a number-average molecular weight in the vicinity of 3554 g/mol, or else “Voranol CP1050” from Dow with a number-average molecular weight in the vicinity of 1078 g/mol.

The polyester polyols that can be used to prepare the abovementioned polyurethane A) can be chosen from:
polyester polyols resulting from the polycondensation of at least one dicarboxylic acid, or of at least one of its corresponding anhydrides or diesters, with at least one diol,
polyester polyols of the estolide polyol type resulting from the condensation of at least one hydroxycarboxylic acid (e.g. ricinoleic acid) or at least one ester thereof, with at least one diol,
polyester polyols resulting from a polymerization with ring opening of at least one cyclic lactone with at least diol, such as polycaprolactone polyols.

The dicarboxylic acids that can be used for the synthesis of the abovementioned polyester polyols are linear or branched, cyclic or acyclic, saturated or unsaturated, and aromatic or aliphatic, and preferably comprise from 3 to 40 carbon atoms and more preferentially from 5 to 10 carbon atoms. Said acid may be, for example, succinic acid, adipic acid, sebacic acid, azelaic acid, or mixtures thereof.

The diols that can be used for the synthesis of the abovementioned polyester polyols can be chosen from polyalkylene diols, polyoxyalkylene diols and the mixtures of these compounds, the (saturated)alkylene part of these compounds preferably being linear or branched and comprising preferably from 2 to 40 carbon atoms and more preferentially from 2 to 8 carbon atoms. Said diol may be, for example, monoethylene glycol, diethylene glycol, 1,2-propanediol, 1,3-propanediol, 1,4-butanediol, 1,6-hexanediol, or mixtures thereof.

The cyclic lactones that can be used for the synthesis of the abovementioned polyester polyols preferably comprise from 3 to 7 carbon atoms.

The polyester polyols that can be used to prepare the abovementioned polyurethane A) can be prepared conventionally and/or are typically available commercially.

The polyester polyols that can be used to prepare the abovementioned polyurethane A) can in particular be amorphous polyester polyols which may have a number-average molecular weight ranging from 800 to 5000 g/mol, preferably from 800 to 3000 g/mol. They may have a Brookfield viscosity of less than or equal to 10 000 mPa·s at 25° C., preferably ranging from 1000 mPa·s to 5000 mPa·s.

In the context of the invention, and unless otherwise stated, the term “amorphous polyester polyol” means a polyester polyol which is shown not to have a melting point when analyzed by differential scanning calorimetry (DSC).

According to a preferred embodiment, the polyol is chosen from polyether polyols.

According to one embodiment, the abovementioned polyurethane A) is obtained from:
a composition comprising at least one polyoxyalkylene polyol (preferably polyoxyalkylene triol), the (saturated) linear or branched alkylene part of which comprises from 2 to 4 carbon atoms, and preferably from 2 to 3 carbon atoms,
a composition comprising at least polymeric MDI.

The polyaddition step can be carried out in amounts of polyisocyanate(s) and polyol(s) such that the NCO/OH molar ratio is strictly greater than 1, for example between 1.1 and 10, preferably between 5 and 8.

In the context of the invention, and unless otherwise mentioned, the NCO/OH molar ratio corresponds to the molar ratio of the number of isocyanate (NCO) groups to the number of hydroxyl (OH) groups respectively borne by the polyisocyanates and the polyols used.

The polyurethane A) as defined above may be prepared in the presence or absence of at least one reaction catalyst, preferentially at a reaction temperature T1 below 95° C. and preferably ranging from 65° C. to 80° C., and more preferably under anhydrous conditions.

### B) Polyisocyanate Compound

The —NCO component may comprise a polyisocyanate compound B) comprising at least one polyisocyanate P comprising at least three NCO functions.

The polyisocyanate compound B) may consist of the polyisocyanate P alone, or may be a mixture of polyisocyanates, said mixture necessarily comprising at least one polyisocyanate P as defined in the present invention.

The polyisocyanate P may be chosen from biurets, isocyanurates, and adducts of diisocyanate and triols.

The polyisocyanate P may be chosen from aromatic polyisocyanates, and in particular from those having the following formula:

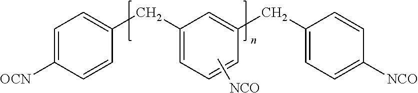

wherein n can vary from 1 to 8, preferably from 1 to 5.

According to a preferred embodiment, the polyisocyanate compound B) is a mixture of polyisocyanates comprising at least one polyisocyanate P comprising at least three NCO functions. It may be a mixture comprising:
at least one diisocyanate monomer; and
at least one polyisocyanate P having at least three NCO functions.

When the polyisocyanate compound B) is a mixture, the average NCO functionality of the mixture may be greater than 2, preferably ranging from 2.3 to 3.5, and even more preferentially from 2.7 to 3.0.

The “average NCO functionality of a mixture” is understood to mean the average number of NCO functions per mole of mixture.

The diisocyanate monomers may be aliphatic, cycloaliphatic or aromatic monomers, preferably aromatic monomers.

Preferably, the polyisocyanate compound B) is a mixture comprising:
at least one MDI monomer;
at least one polyisocyanate P having the following formula:

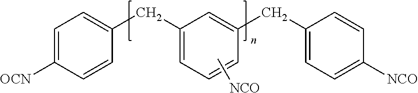

wherein n can vary from 1 to 8, preferably from 1 to 5.

This type of mixture is typically available from Dow Chemical Company under the trade name Voranate PAPI®20, PAPI®27, M229 and from BorsodChem under the trade name Ongronat®2510 which are polymeric MDIs (PMDIs).

The —NCO component may comprise a weight content of NCO groups ranging from 10% to 30%, preferably from 12% to 24%, by weight relative to the total weight of said-NCO component.

The —NCO component can be prepared by simple mixing of its ingredients at room temperature (23° C.), preferentially under anhydrous conditions.

The —NCO component according to the invention may comprise more than 50% by weight, preferably more than 60% by weight, and even more preferentially more than 65% by weight of polyurethane (A) as defined above, relative to the total weight of said-NCO component.

The —NCO component according to the invention may comprise more than 50% by weight, preferably more than 60% by weight, and even more preferentially more than 70% by weight of polyurethane (A) as defined above, relative to the total weight of said-NCO component.

According to a first embodiment, the —NCO component according to the invention comprises:
from 1% to 40% by weight, preferably from 5% to 30% by weight, of polyurethane(s) A) as defined above; and
from 50% to 90% by weight, preferably from 55% to 80% by weight, of polyisocyanate compound(s) B) as defined above.

According to a second embodiment, the —NCO component according to the invention comprises:
more than 50% by weight, preferably from 55% to 90% by weight, of polyurethane(s) A) as defined above; and
from 1% to 20% by weight, preferably from 5% to 15% by weight, of polyisocyanate compound(s) B) as defined above.

Preferably, the —NCO component comprises the polyisocyanate compound B).

### Filler

The —NCO component may comprise at least one filler.

The filler may be chosen from mineral fillers, molecular sieves, zeolites, organic fillers, and mixtures thereof.

As examples of mineral filler, use may be made of any mineral filler customarily used in the field of adhesive compositions. These fillers are typically in the form of particles of diverse geometry. They may be, for example, spherical or fibrous or may have an irregular shape.

The mineral fillers may be chosen from the group consisting of clays, quartz, carbonate fillers, kaolin, gypsum, hollow glass microspheres, and mixtures thereof.

Some of these fillers may be untreated or treated, for example treated using an organic acid, such as stearic acid, or a mixture of organic acids predominantly consisting of stearic acid.

The hollow glass microspheres may be those made of soda-lime borosilicate or of aluminosilicate. They may, for example, be the glass bead microspheres sold by the company 3M.

The hollow glass microspheres may have an average particle size (D50v) ranging from 1 to 70 μm, preferably from 20 to 60 μm.

The hollow glass microspheres may have a density ranging from 0.100 to 0.600 g/cm³, preferably from 0.150 to 0.300 g/cm³.

The term “mean particle size”, including fillers or hollow microspheres, means the size measurement for a volume particle size distribution and corresponding to 50% by volume of the sample of particles analyzed. When the particles are spherical, the mean particle size corresponds to the median diameter (D50 or Dv50) which corresponds to the diameter such that 50% by volume of the particles have a size expressed in micrometers and determined according to the standard NF ISO 13320-1 (1999) by laser diffraction on apparatus of Malvern type.

The term “sphere” or “spherical”, including the fillers or hollow microspheres, means a particle having an aspect ratio close to 1, ranging from 0.5 to 1.5, for example such as oblong, ovoid or ellipsoidal particles, and preferably equal to 1, i.e. having a spherical shape. Such an aspect ratio is defined as the ratio of the maximum distance between two points on the surface of the particle, along a main direction, to the minimum distance between two points on the surface of the particle, along a direction substantially perpendicular to the main direction.

The carbonate fillers may be chosen from alkali metal or alkaline earth metal carbonates, and more particularly calcium carbonate or chalk.

As examples of organic filler, use may be made of any organic and in particular polymeric fillers customarily used in the field of adhesive compositions.

Use may be made, for example, of polyvinyl chloride (PVC), polyolefins, rubber, ethylene/vinyl acetate (EVA) or aramid fibers, such as Kevlar®.

Use may also be made of expandable or non-expandable hollow microspheres made of thermoplastic polymer. Mention may in particular be made of hollow microspheres made of vinylidene chloride/acrylonitrile.

The average particle size of the organic filler is preferably less than or equal to 50 μm, preferably between 5 and 20 μm.

Preferably, the —NCO component comprises from 0% to 10% by weight, preferably from 2% to 8% by weight, and even more preferentially from 3% to 8% by weight, of hollow glass microspheres, relative to the total weight of said-NCO component.

### Additives

The —NCO component can comprise at least one additive chosen from the group consisting of plasticizers, catalysts, solvents, pigments, adhesion promoters, moisture absorbers, UV stabilizers (or antioxidants), dyes, rheological agents and mixtures thereof.

The total content of abovementioned additive(s) in the —NCO component can range from 0% to 40% by weight, preferably from 1% to 35% by weight, advantageously from 5% to 30% by weight, relative to the total weight of said-NCO component.

Preferably, the —NCO component does not comprise a solvent, it being possible for said solvent to be an organic solvent, such as ethyl acetate, methyl ethyl ketone, tetrahydrofuran, methyltetrahydrofuran, or else Isane® (based on isoparaffins, available from Total) or Exxol® D80 (based on aliphatic hydrocarbons, available from ExxonMobil Chemical) or else chlorobenzene, naphtha, acetone, n-heptane or xylene.

As examples of rheological (thixotropic) agent(s), mention may be made of any rheological agent customarily used in the field of adhesive compositions or sealants.

Preferably, the rheological/thixotropic agents are chosen from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
fumed silica, which is optionally modified, as sold, for example, under the name HDK® N20 by Wacker;
urea derivatives resulting from the reaction of an aromatic diisocyanate monomer, such as 4,4′-MDI, with an aliphatic amine, such as butylamine. The preparation of such urea derivatives is described in particular in the application FR 1 591 172;
micronized amide waxes, such as for example Crayvallac SLX sold by Arkema.

Preferably, the —NCO component comprises at least one rheological/thixotropic agent, even more preferentially in a content ranging from 5% to 20% by weight relative to the total weight of said —NCO component.

The —NCO component may comprise a weight content of NCO groups ranging from 13% to 23%, preferably from 15% to 20%, by weight relative to the total weight of said-NCO component.

The —NCO component can be prepared by simple mixing of its ingredients at room temperature (23° C.), preferentially under anhydrous conditions.

### —OH Component

### Polyol P1

The —OH component comprises at least one polybutadiene polyol P1 comprising at least two hydroxyl functions, said polyol P1 having a number-average molecular weight ranging from 1000 g/mol to 15 000 g/mol.

The polybutadiene polyol may be a homopolymer or a copolymer.

If it is a copolymer, the content of comonomer is less than 50% by weight of the polybutadiene polyol. The comonomer may be chosen from ethylene, propylene, isoprene, farnesene, dicyclopentadiene and mixtures thereof.

Preferably, the polybutadiene polyol is a homopolymer.

The polybutadiene polyol P1 according to the invention also covers the partially hydrogenated derivatives thereof.

The polybutadiene polyol P1 preferably comprises terminal hydroxyl functions.

In the context of the invention, and unless otherwise mentioned, the “terminal hydroxyl functions” of a polybutadiene is understood to mean the hydroxyl functions located at the ends of the main chain of the polybutadiene.

The polybutadiene polyol P1 may have an average number of hydroxyl functions per molecule of greater than or equal to 2.

In particular, the ratio of cis-1,4, trans-1,4 and 1,2-vinyl unsaturations present in the polybutadiene is not critical.

The number and the position of the hydroxyl functions in the polybutadiene P1 may depend on the preparation process. Such methods are described, for example, in U.S. Pat. No. 5,303,843 or U.S. Pat. No. 5,418,296.

The polybutadiene polyol P1 may have a number-average molecular weight (Mn) ranging from 1500 to 10 000 g/mol, and preferably from 2000 to 5000 g/mol.

Commercially available polybutadiene polyols are also found, such as, for example, Poly bd® from Cray Valley or Idemitsu, or else POLYVEST® HT from Evonik.

The total content of polyol(s) P1 can range from 1% to 30% by weight, preferably from 2% to 20% by weight, and even more preferentially from 3% to 8% by weight, relative to the total weight of said-OH component.

### Polyol P2

The —OH component comprises a polyol P2 chosen from diols, triols or mixtures thereof, said polyol P2 having a number-average molecular weight or number-average molar mass ranging from 60 to 500 g/mol, preferably from 60 to 250 g/mol.

The polyol P2 may be chosen from the group consisting of estolide polyols resulting from the polycondensation of one or more hydroxy acids, such as ricinoleic acid, with a diol (mention may be made, for example, of Polycin® D-265, Polycin® D-290 and Polycin® T-400 available from Vertellus).

The polyol P2 may be chosen from the group consisting of linear or branched aliphatic, or cycloaliphatic diols, such as ethylene glycol (CAS: 107-21-1), diethylene glycol, triethylene glycol, tetraethylene glycol, propane-1,2-diol, dipropylene glycol, tripropylene glycol, tetrapropylene glycol, hexane-1,6-diol, 3-ethyl-2-methylpentane-1,5-diol, 2-ethyl-3-propylpentane-1,5-diol, 2,4-dimethyl-3-ethylpentane-1,5-diol, 2-ethyl-4-methyl-3-propylpentane-1,5-diol, 2,3-diethyl-4-methylpentane-1,5-diol, 3-ethyl-2,2,4-trimethylpentane-1,5-diol, 2,2-dimethyl-4-ethyl-3-propylpentane-1,5-diol, 2-methyl-2-propylpentane-1,5-diol, 2,4-dimethyl-3-ethyl-2-propylpentane-1,5-diol, 2,3-dipropyl-4-ethyl-2-methylpentane-1,5-diol, 2-butyl-2-ethylpentane-1,5-diol, 2-butyl-2,3-diethyl-4-methylpentane-1,5-diol, 2-butyl-2,4-diethyl-3-propylpentane-1,5-diol, 3-butyl-2-propylpentane-1,5-diol, 2-methylpentane-1,5-diol (CAS: 42856-62-2), 3-methylpentane-1,5-diol (MPD, CAS: 4457-71-0), 2,2-dimethylpentane-1,3-diol (CAS: 2157-31-5), (CAS: 3121-82-2), 3,3-dimethylpentane-1,5-diol (CAS: 53120-74-4), 2,3-dimethylpentane-1,5-diol (CAS: 81554-20-3), 2,2-dimethyl-1,3-propanediol (neopentyl glycol-NPG, CAS: 126-30-7), 2,2-diethylpropane-1,3-diol (CAS: 115-76-4), 2-methyl-2-propylpropane-1,3-diol (CAS: 78-26-2), 2-butyl-2-ethylpropane-1,3-diol (CAS: 115-84-4), 2-methylpropane-1,3-diol (CAS: 2163-42-0), 2-benzyloxypropane-1,3-diol (CAS: 14690-00-7), 2,2-dibenzylpropane-1,3-diol (CAS: 31952-16-6), 2,2-dibutylpropane-1,3-diol (CAS: 24765-57-9), 2,2-diisobutylpropane-1,3-diol, 2,4-diethylpentane-1,5-diol, 2-ethylhexane-1,6-diol (CAS: 15208-19-2), 2,5-dimethylhexane-1,6-diol (CAS: 49623 Nov. 2), 5-methyl-2-(1-methylethyl) hexane-1,3-diol (CAS: 80220 Jul. 1), 1,4-dimethylbutane-1,4-diol, hexane-1,5-diol (CAS: 928-40-5), 3-methylhexane-1,6-diol (CAS: 4089-71-8), 3-tert-butylhexane-1,6-diol (CAS: 82111-97-5), heptane-1,3-diol (CAS: 23433 Apr. 7), octane-1,2-diol (CAS: 1117-86-8), octane-1,3-diol (CAS: 23433 May 8), 2,2,7,7-tetramethyloctane-1,8-diol (CAS: 27143-31-3), 2-methyloctane-1,8-diol (CAS: 109359-36-6), 2,6-dimethyloctane-1,8-diol (CAS: 75656-41-6), octane-1,7-diol (CAS: 3207-95-2), cyclohexanedimethanol (CAS number: 105-08-8), 4,4,5,5-tetramethyl-3,6-dioxaoctane-1,8-diol (CAS: 76779-60-7), 2,2,8,8-tetramethylnonane-1,9-diol (CAS: 85018-58-2), nonane-1,2-diol (CAS: 42789-13-9), 2,8-dimethylnonane-1,9-diol (CAS: 40326-00-9), nonane-1,5-diol (CAS: 13686-96-9), 2,9-dimethyl-2,9-dipropyldecane-1,10-diol (CAS: 85018-64-0), 2,9-dibutyl-2,9-dimethyldecane-1,10-diol (CAS: 85018-65-1), 2,9-dimethyl-2,9-dipropyldecane-1,10-diol (CAS: 85018-64-0), 2,9-diethyl-2,9-dimethyldecane-1,10-diol (CAS: 85018-63-9), 2,2,9,9-tetramethyldecane-1,10-diol (CAS: 35449-36-6), 2-nonyldecane-1,10-diol (CAS: 48074-20-0), decane-1,9-diol (CAS: 128705-94-2), 2,2,6,6,10,10-hexamethyl-4,8-dioxaundecane-1,11-diol (CAS: 112548-49-9), 1-phenylundecane-1,11-diol (CAS: 109217-58-5), 2-octylundecane-1,11-diol (CAS: 48074-21-1), 2,10-diethyl-2,10-dimethylundecane-1,11-diol (CAS: 85018-66-2), 2,2,10,10-tetramethylundecane-1,11-diol (CAS: 35449-37-7), 1-phenylundecane-1,11-diol (CAS: 109217-58-5), undecane-1,2-diol (CAS: 13006-29-6), dodecane-1,2-diol (CAS: 1119-87-5), dodecane-2,11-diol (CAS: 33666-71-6), 2,11-diethyl-2,11-dimethyldodecane-1,12-diol (CAS: 85018-68-4), 2,11-dimethyl-2,11-dipropyldodecane-1,12-diol (CAS: 85018-69-5), 2,11-dibutyl-2,11-dimethyldodecane-1,12-diol (CAS: 85018-70-8), 2,2,11,11-tetramethyldodecane-1,12-diol (CAS: 5658-47-9), dodecane-1,11-diol (CAS: 80158-99-2), 11-methyldodecane-1,7-diol (CAS: 62870-49-9), dodecane-1,4-diol (CAS: 38146-95-1), dodecane-1,3-diol (CAS: 39516-24-0), dodecane-1,10-diol (CAS: 39516-27-3), 2,11-dimethyldodecane-2,11-diol (CAS: 22092-59-7), dodecane-1,5-diol (CAS: 20999-41-1), dodecane-6,7-diol (CAS: 91635-53-9), dodecane-1,12-diol (CAS: 5675-51-4), and alkoxylated derivatives of these diols.

The polyol P2 may be chosen from the group consisting of linear or branched aliphatic, or cycloaliphatic triols, such as glycerol (CAS: 56-81-5), hexane-1,2,6-triol (CAS: 106-69-4), butane-1,2,4-triol (CAS 3068-00-6), pentane-1,2,5-triol (CAS 14697-46-2), hexane-1,2,6-triol (CAS 106-69-4), hexane-1,2,5-triol (CAS 10299-30-6), octahydro-4,7-methano-1H-indene-1,2,5-triol (CAS 13318-18-8), trimethylolalkanes comprising from 1 to 20 carbon atoms and 3 methylol groups among which mention may for example be made of trimethylolmethane (CAS: 4704-94-3), trimethylolethane (CAS: 77-85-0), trimethylolpropane (CAS: 77-99-6), trimethylolbutane (CAS: 7426-71-3), trimethylolisobutane (CAS: 20762-78-1), trimethylolpentane (CAS: 4704-89-6), trimethylolhexane (CAS: 20762-79-2), trimethylolheptane, trimethyloloctane, trimethylolnonane, trimethyloldecane, trimethylolundecane, trimethyloldodecane, octahydro-4,7-methano-1H-indene-1.2,5-triol (CAS: 13318-18-8), cyclohexane-1,3,5-triol or phloroglucitol (CAS: 2041-15-8), and alkoxylated derivatives of these triols.

The polyol P2 may be chosen from polyoxyalkylene diols or triols. Preferably, the polyoxyalkylene diols or triols are chosen from polyoxypropylene triols.

As an example of a polyoxyalkylene triol, mention may be made, for example, of Voranol CP450 from Dow.

Preferably, the diol P2 is chosen from the group consisting of ethylene glycol, diethylene glycol, propylene glycol, dipropylene glycol, propane-1,3-diol, butane-1,4-diol, neopentyl glycol, 2-methylpropane-1,3-diol, hexane-1,6-diol, 2-ethylhexane-1,3-diol, and mixtures thereof.

Even more preferably, the polyol P2 is chosen from 2-ethylhexane-1,3-diol, dipropylene glycol and mixtures thereof.

The total content of polyol(s) P2 can range from 1% to 50%, preferably from 5% to 40%, and even more preferentially from 10% to 30% by weight, relative to the total weight of the —OH component.

### Polyol P3

The —OH component comprises at least one polyol P3 having a hydroxyl functionality of greater than or equal to 2, said polyol P3 being chosen from the group consisting of polyether polyols, polyols of natural origin, polyester polyols, and mixtures thereof, said polyol P3 having a number-average molecular weight ranging from 800 to 5000 g/mol.

The number-average molecular weight of the polyol P3 ranges preferably from 800 g/mol to 2500 g/mol, preferentially from 800 g/mol to 2000 g/mol and even more preferentially from 800 g/mol to 1500 g/mol.

The polyester polyols can be chosen from polyester diols and polyester triols, and preferably from polyester triols.

The polyester polyols can result from the polycondensation:
of one or more aliphatic (linear, branched or cyclic) or aromatic polyols, for instance monoethylene glycol, diethylene glycol, propane-1,2-diol, propane-1,3-diol, butane-1,4-diol, butenediol, hexane-1,6-diol, cyclohexanedimethanol, tricyclodecanedimethanol, neopentyl glycol, cyclohexanedimethanol, glycerol, trimethylolpropane, hexane-1,2,6-triol, N-methyldiethanolamine, triethanolamine, a fatty alcohol dimer, a fatty alcohol trimer, and mixtures thereof, with
one or more polycarboxylic acids or an ester or anhydride derivative thereof, such as 1,6-hexanedioic acid (adipic acid), dodecanedioic acid, azelaic acid, sebacic acid, adipic acid, 1,18-octadecanedioic acid, phthalic acid, isophthalic acid, terephthalic acid, succinic acid, a fatty acid dimer, a fatty acid trimer and the mixtures of these acids, an unsaturated anhydride, such as, for example, maleic or phthalic anhydride, or a lactone, such as, for example, caprolactone;
estolide polyols resulting from the polycondensation of one or more hydroxy acids, such as ricinoleic acid, with a diol (examples that may be mentioned include Polycin® D-1000 and Polycin® D-2000 available from Vertellus).

The abovementioned polyester polyols may be prepared conventionally and are for the most part available commercially.

Among the polyester polyols, mention may for example be made of the following product with a hydroxyl functionality of greater than or equal to 2: caprolactone CAPA3050 from Ingevity.

The polyols of natural origin cover in particular the derivatives thereof such as, for example, hydrophobic derivatives. The polyols of natural origin may be chosen from the group consisting of castor oil, or hydroxylated derivatives of unsaturated natural oils such as, for example, soybean oil, rapeseed oil or sunflower oil, and mixtures thereof.

Hydrophobic derivatives of polyols of natural origin can be found commercially, such as, for example, castor oil oligoesters available from Vandeputte Oleochemicals, Setathane® D1150 (branched hydrophobic liquid polyol derived from castor oil, having a number-average molecular weight in the region of 980 g/mol) sold by Allnex, and Sovermol® 805 sold by BASF.

The polyester polyols of natural origin (including derivatives thereof) may have a number-average molecular weight ranging from 800 to 5000 g/mol, preferably from 800 to 3000 g/mol, and they may have a Brookfield viscosity of less than or equal to 10 000 mPa·s at 25° C., preferably ranging from 1000 mPa·s to 5000 mPa·s.

The polyol P3 may have a hydroxyl functionality of greater than or equal to 2, preferably greater than or equal to 2.5, and even more preferentially greater than or equal to 3.

The polyether polyols may be chosen from polyoxyalkylene polyols, the (saturated) linear or branched alkylene part of which comprises from 2 to 4 carbon atoms, and preferably from 2 to 3 carbon atoms.

The polyether polyols are preferably chosen from polyoxyalkylene diols or polyoxyalkylene triols, and better still from polyoxyalkylene triols, the linear or branched alkylene part of which comprises from 1 to 4 carbon atoms, preferably from 2 to 3 carbon atoms.

As examples of polyoxyalkylene diols or triols which can be used according to the invention, mention may for example be made of polyoxypropylene diol or triol (also denoted by polypropylene glycol (PPG)diol or triol), polyoxyethylene diol or triol (also denoted by polyethylene glycol (PEG)diol or triol) and polyoxybutylene glycols (also denoted by polybutylene glycol (PBG)diol or triol), copolymers or terpolymers of PPG/PEG/PBG diol or triol, polytetrahydrofuran (PolyTHF)diol or triol, polytetramethylene glycols (PTMG), and mixtures thereof.

Preferably, the polyether polyols are chosen from polyoxypropylene triols. The abovementioned polyether polyols can be prepared conventionally and are widely available commercially. They can, for example, be obtained by polymerization of the corresponding alkylene oxide in the presence of a catalyst based on a double metal/cyanide complex.

Mention may be made, as example of polyether triols, of the polyoxypropylene triol sold under the name “Voranol CP3355” by Dow, with a number-average molecular weight in the vicinity of 3554 g/mol, or else “Voranol CP1050” from Dow with a number-average molecular weight in the vicinity of 1078 g/mol.

According to a preferred embodiment, the polyol P3 is chosen from polyether triols and derivatives of polyols of natural origin.

The total content of polyol(s) P3 can range from 5% to 40%, preferably from 5% to 30%, and even more preferentially from 8% to 20% by weight, relative to the total weight of the —OH component.

### Filler

The —OH component comprises at least one filler, the total content of filler(s) being greater than or equal to 30% by weight relative to the total weight of said —OH component.

The filler may be chosen from mineral fillers, molecular sieves, zeolites, organic fillers, and mixtures thereof.

As examples of mineral filler, use may be made of any mineral filler customarily used in the field of adhesive compositions. These fillers are typically in the form of particles of diverse geometry. They may be, for example, spherical or fibrous or may have an irregular shape.

The mineral fillers may be chosen from the group consisting of clays, quartz, carbonate fillers, kaolin, gypsum, hollow glass microspheres, and mixtures thereof.

Some of these fillers may be untreated or treated, for example treated using an organic acid, such as stearic acid, or a mixture of organic acids predominantly consisting of stearic acid.

The hollow glass microspheres may be those made of soda-lime borosilicate or of aluminosilicate. They may, for example, be the glass bead microspheres sold by the company 3M.

The hollow glass microspheres may have an average particle size (D50v) ranging from 1 to 70 μm, preferably from 20 to 60 μm.

The hollow glass microspheres may have a density ranging from 0.100 to 0.600 g/cm³, preferably from 0.150 to 0.300 g/cm³.

The carbonate fillers may be chosen from alkali metal or alkaline earth metal carbonates, and more particularly calcium carbonate or chalk.

As examples of organic filler, use may be made of any organic and in particular polymeric fillers customarily used in the field of adhesive compositions.

Use may be made, for example, of polyvinyl chloride (PVC), polyolefins, rubber, ethylene/vinyl acetate (EVA) or aramid fibers, such as Kevlar®.

Use may also be made of expandable or non-expandable hollow microspheres made of thermoplastic polymer. Mention may in particular be made of hollow microspheres made of vinylidene chloride/acrylonitrile.

The average particle size of the organic filler is preferably less than or equal to 50 μm, preferably between 5 and 20 μm.

The —OH component may comprise a total amount of filler(s) of greater than or equal to 40% by weight, preferentially greater than or equal to 45% by weight, and advantageously greater than or equal to 50% by weight, relative to the total weight of the —OH component.

Preferably, the —OH component comprises:
at least one carbonate filler, preferably in a content of greater than or equal to 35% by weight, preferentially of greater than or equal to 40% by weight, relative to the total weight of said-OH component;
from 0% to 10% by weight, preferably from 2% to 8% by weight, and even more preferentially from 3% to 8% by weight of hollow glass microspheres relative to the total weight of said-OH component.

### Additives

The —OH component can comprise at least one additive chosen from the group consisting of plasticizers, catalysts, solvents, pigments, adhesion promoters, moisture absorbers, UV stabilizers (or antioxidants), dyes, rheological agents and mixtures thereof.

The total content of abovementioned additive(s) in the —OH component can range from 0% to 30% by weight, preferably from 1% to 25% by weight, advantageously from 1% to 20% by weight, relative to the total weight of said-OH component.

As examples of rheological (thixotropic) agent(s), mention may be made of any rheological agent customarily used in the field of adhesive compositions or sealants.

Preferably, the rheological/thixotropic agents are chosen from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6,
fumed silica, which is optionally modified, as sold, for example, under the name HDK® N20 by Wacker;
urea derivatives resulting from the reaction of an aromatic diisocyanate monomer, such as 4,4′-MDI, with an aliphatic amine, such as butylamine. The preparation of such urea derivatives is described in particular in the application FR 1 591 172;
micronized amide waxes, such as Crayvallac SLX sold by Arkema.

Preferably, the —OH component comprises at least one rheological/thixotropic agent, even more preferentially in a content ranging from 1% to 8% by weight relative to the total weight of said —OH component.

### Composition

The composition according to the invention may be an adhesive composition or a sealant composition.

The volume ratio of —OH component/—NCO component in the composition may range from 1/3 to 3/1, preferably from 1/2 to 2/1, said volume ratio advantageously being equal to 1/1.

The composition according to the invention advantageously exhibits at least one of the following properties:
good rheological properties: reduction or even absence of flow (or sag) of the mixture which has not yet crosslinked, notably when applied in a vertical position;
readily extrudable, notably when applied as beads;
a fairly long pot life (for example of more than 5 min, preferably more than 10 min, or even more than 30 minutes);
results, after crosslinking, in an adhesive joint with good structural and flexible properties over a broad temperature spectrum, for example between −60° C. and 50° C.

After crosslinking, the adhesive joint advantageously has two glass transition temperatures, namely:
a glass transition temperature Tg1 advantageously between −80° C. and −65° C.;
a glass transition temperature Tg2 advantageously between 40° C. and 85° C.

The glass transition temperature is determined by dynamic mechanical analysis, in particular as described in the experimental section.

### B. Ready-to-Use Kit

The present invention also relates to a ready-to-use kit, comprising the OH component as defined above, on the one hand, and the NCO component as defined above, on the other hand, packaged in two separate compartments.

Specifically, the composition according to the invention may be in a two-component form, for example in a ready-to-use kit, comprising the OH component, on the one hand, in a first compartment or drum and the NCO component, on the other hand, in a second compartment or drum, in proportions suitable for direct mixing of the two components, for example by means of a metering pump.

According to one embodiment of the invention, the kit also comprises one or more means for mixing the two components OH and NCO. Preferably, the mixing means are chosen from metering pumps or static mixers with a diameter suited to the amounts used.

### C. Uses

The present invention also relates to the use of a composition as defined above as adhesive, sealant or coating. The sealants may for example be an adhesive bonding sealant, anti-flutter sealant and/or caulking sealant. It is preferably an adhesive bonding sealant.

The composition may be used in particular for adhesive bonding in the field of structural assembly such as the automotive, aeronautical and/or construction industries.

In the motor vehicle sector, it may be a case of adhesively bonding metal parts close to the engine.

The present invention also relates to a process for assembling two substrates by adhesive bonding, comprising:
the coating, onto at least one of the two substrates to be assembled, of an adhesive composition obtained by mixing the —OH and —NCO components as defined above; then
effectively bringing the two substrates into contact.

The appropriate substrates are, for example, inorganic substrates, such as concrete, metals or alloys (such as aluminum alloys, steel, nonferrous metals and galvanized metals); or else organic substrates, such as wood, plastics, such as PVC, polycarbonate, PMMA, polyethylene, polypropylene, polyesters or epoxy resins; substrates made of metal and composites coated with paint (as in the motor vehicle sector, for example).

All the embodiments described above may be combined with each other. In particular, the various abovementioned constituents of the composition, and notably the preferred embodiments of the composition, may be combined with each other.

In the context of the invention, the term “between x and y” or “ranging from x to y” means a range wherein the limits x and y are included. For example, the range “between 0% and 25%” notably includes the values 0% and 25%.

The invention is now described in the following implementation examples, which are given purely by way of illustration and should not be interpreted in order to limit the scope thereof.

### Examples

The following ingredients were used:
Voranate™ M229 available from Dow is a low-viscosity polymeric MDI (PMDI) with an NCO percentage=31.4% and an average functionality equal to 2.7.
Ongronat® 2510 available from BorsodChem is a low-viscosity polymeric MDI (PMDI) with an NCO percentage=31.0% and an average functionality equal to 2.9.
Voranol™ CP1050 available from Dow is a polypropylene glycol of functionality 3 having an OHN=156 mg KOH/g, i.e. a number-average molecular weight (Mn) of 1078 g/mol.
Siliporite® SA 1720 sold by the company Arkema is a 3A molecular sieve.
Aerosil® R202 available from Evonik is a hydrophobic fumed silica post-treated with a polydimethysiloxane with a (BET) specific surface area of 100±20 m²/g.
Gel Paste, available from BOSTIK, is a rheological agent consisting of a dispersion of a diurea adduct (MDI/butylamine) in a plasticizer (DIDP).
2-ETHYLHEXANE-1,3-DIOL (CAS No.: 94-96-2) available from Monument Chemical is a branched aliphatic diol having a molar mass of 146.23 g/mol.
DIPROPYLENE GLYCOL (CAS No.: 25265-71-8) available from Dow is a diol having a molar mass of 134.17 g/mol.
POLYVEST® HT available from Evonik is a liquid polybutadiene diol with an OHN=45-51 mg KOH/g, i.e. a number-average molecular weight (Mn) ranging from 2200 to 2500 g/mol, and a viscosity ranging from 4000 to 5500 mPa·s at 30° C.
Setathane® D1150 available from Allnex is a branched hydrophobic liquid polyol derived from castor oil having an OH content=4.7%, i.e. an OHN=155 mg KOH/g and an average molar mass in the region of 980 g/mol and a viscosity ranging from 3000 to 4000 mPa·s at 23° C.
Mikhart® 10 available from La Provencale is a calcium carbonate having an average diameter of 10 μm.
Calofort® SV14 available from Mineral Technologies and Hakuenka CCR S10 available from Shiraishi Omya are precipitated calcium carbonates (PCC) treated with a calcium stearate having an average diameter of 70 nm.
Thixatrol® AS 8053 available from Elementis is a powdered rheological agent of the diamide type having an average diameter of less than 5 mm and a melting point ranging from 120 to 130° C.
DOWSIL™ 163 Additive available from Dow is a silicone antifoam.

### Example 1: Preparation of the —NCO Component

### 1.A. Preparation of NCO-Terminated Polyurethanes (PU1 and PU2):

The NCO-terminated polyurethanes PU used in the following examples were prepared using the various ingredients shown in table 1. The amounts of polyisocyanate(s) and of polyol(s) used (expressed as % by weight of commercial product, relative to the weight of —NCO component) correspond to an NCO/OH mole ratio (r1) of about 7, as shown in table 1.

The polyisocyanate(s) and the polyol(s) are mixed in a reactor kept under constant stirring and under nitrogen, at a temperature T1 ranging from 65° C. to 80° C. The temperature is controlled so as not to exceed 82° C.

The whole is kept mixing at this temperature until the hydroxyl functions of the polyols have been completely consumed.

The degree of progress of the reaction is monitored by measuring the content of NCO group by back titration of dicyclohexylamine using hydrochloric acid, according to the internal method of assay of the free NCOs. The reaction is halted when the content of NCO group measured is approximately equal to the content of NCO group desired.

### Preparation of the Polyurethanes PU1 and PU2

| NCO-terminated PU | | PU1 | PU2 |
|---|---|---|---|
| | VORANATE ® M229 | 72 | — |
| | ONGRONAT ® 2510 | — | 72 |
| | VORANOL ® CP1050 | 28 | 28 |

| | | |
|---|---|---|
| weight % | 100 | 100 |
| NCO/OH mole ratio (r₁) | 7 | 7 |
| % NCO | 19 | 19 |

### 1.B. Preparation of the —NCO Component by Mixing its Ingredients:

The NCO-terminated polyurethane obtained is then mixed with the other ingredients constituting the —NCO component, in the proportions indicated in table 2 (expressed as % by weight of commercial product relative to the total weight of —NCO component), in the same reactor maintained under constant stirring and under nitrogen.

After homogenization of the mixture (30 to 120 minutes), the content of NCO group in the —NCO component is measured respectively.

The content of NCO group in the —NCO component, expressed as percentage by weight relative to the weight of the —NCO component (% NCO), is measured according to the standard NF T52-132.

TABLE 2

| | NCO component | NCO component |
|---|---|---|
| | no. 1 | no. 2 |
| Polyurethane PU1 | 79.6 | — |
| Polyurethane PU2 | — | 14 |
| VORANATE ® M 229 | — | 68 |
| Siliporite ® SA 1720 | 5.05 | 4.4 |
| Gel paste | 15.35 | 13.60 |

| | | |
|---|---|---|
| Total of the ingredients of | 100 | 100 |
| the —NCO component | | |
| NCO weight % of the NCO | 15.5 | 23.8 |
| component | | |

### Example 2: Preparation of the —OH Component

The different ingredients constituting the —OH component are mixed in the proportions shown in table 3, at a temperature ranging from 20° C. to 80° C., in a reactor kept constantly stirred and under nitrogen.

After homogenization of the mixture (approximately 3 hours), the content of OH group in the —OH component, expressed in milligrams of KOH per gram of —OH component (mg KOH/g), is measured.

TABLE 3

| | OH component | OH component |
|---|---|---|
| | no. 1 | no. 2 |
| 2-Ethylhexane-1,3-diol | 14.96 | 10.79 |
| Dipropylene glycol | — | 9.88 |
| POLYVEST ® HT | 5.26 | 5.72 |
| VORANOL ® CP1050 | 16.34 | — |
| SETATHANE ® D1150 | — | 10.48 |
| SIEVE SA 1720 | 3.16 | 4.95 |
| MIKHART ® 10 | 47.95 | 50.46 |
| CALOFORT ® SV14 | 8.65 | — |
| THIXATROL ® AS 8053 | 3.16 | 2.91 |
| Black dye | 0.21 | 0.27 |
| DOWSIL 163 | 0.32 | 0.24 |

| | | |
|---|---|---|
| Total of the ingredients of | 100 | 100 |
| the —OH component | | |

### Example 3: Preparation of Adhesive Compositions A and B

The —NCO component prepared in example 1 and the —OH component prepared in example 2 were mixed in the amounts indicated in table 4.

Mixing is performed using a 50 ml twin cartridge at a temperature of about 23° C.

| | | Adhesive | Adhesive |
|---|---|---|---|
| | | composition A | composition B |
| | NCO component | NCO | NCO |
| | | component | component |
| | | no. 1 | no. 2 |
| Mixture | OH component | OH component | OH component |
| of —OH | | no. 1 | no. 2 |
| and —NCO | NCO/OH molar ratio | 1.04 | 1.32 |
| components | | | |
| | Mixture volume ratio | 1/1 | 1/1 |
| | Tg1 measured by DMA | −70° C. | −76° C. |
| | Tg2 measured by DMA | 66° C. | 82° C. |

### Example 4: Evaluation of the Performance Qualities

Flow test: The composition was extruded from a two-component cartridge (comprising the —OH component, on the one hand, and the —NCO component, on the other hand) through a static mixer in order to vertically deposit a bead with a cross section of 1 cm and over a length of 10 to 20 cm.

The bead was checked visually to see whether or not any flow occurred (dimensional stability of the bead).

Pot life: This time is estimated using a medical wooden tongue spatula or tongue depressor (150 mm×19 mm×1.5 mm, rounded ends) in a crucible according to the following protocol:

The —OH and —NCO components were stabilized beforehand at 23° C. 50 ml of mixture of said —NCO and —OH components are weighed out, in a 1/1 volume ratio.

The pot life is the time beyond which no further transfer of adhesive onto the wooden spatula is observed (no more strands). It is evaluated by periodically dipping a new spatula into 1 mm of the mixture, starting from 50% of the theoretical pot life.

### Determination of the Glass Transition by Dynamic Mechanical Analysis (DMA)

Test specimen preparation for DMA analysis: The sealant is poured into a Teflon mold to prepare dumbbell test specimens of the following dimensions: length 20 mm, width 4 mm and thickness 3 mm.

A sample is subjected to a torsional stress from −100° C. to 100° C. The value of the glass transition corresponds to the peak of tan a (ratio of the loss modulus and storage modulus).

The Tests of Intrinsic Mechanical Performance Qualities were Carried Out According to Standard ISO 527-2017).

The measurement of the elongation at break by a tensile test was carried out according to the protocol described below.

The principle of the measurement consists in drawing, in a tensile testing device, the movable jaw of which moves at a constant speed equal to 10 mm/minute, a standard test specimen consisting of the crosslinked composition and in recording, at the moment when the test specimen breaks, the tensile stress applied (in MPa) and also the elongation of the test specimen (in %). The standard test specimen is dumbbell-shaped, as illustrated in the international standard ISO 527. The narrow part of the dumbbell used has a length of 80 mm, a width of 10 mm and a thickness of 4 mm.

The properties obtained for the compositions prepared are summarized in the table below:

| | | Adhesive | Adhesive |
|---|---|---|---|
| | | composition | composition |
| | | A | B |
| Flow test—1 cm bead | | No flow | No flow |
| Pot life (minutes) | | 20 | 50 |
| Intrinsic mechanical | Tensile modulus (MPa) | 16.8 | 27.0 |
| performance tests | Elongation at break (%) | 9.9 | 1.4 |
| (23° C.-50% RH) | Young's modulus (MPa) | 984 | 2460 |
| Intrinsic mechanical | Tensile modulus (MPa) | 8.01 | 22.1 |
| performance tests | Elongation at break (%) | 50.9 | 2.2 |
| (40° C.-50% RH) | Young's modulus (MPa) | 338 | 1480 |

Compositions A and B advantageously lead, after mixing of the OH and NCO components, to an absence of flow after application, notably in the vertical position.

In addition, compositions A and B advantageously have, after crosslinking, a high Young's modulus while having an elongation at break of greater than 1% at 23° C. (1.4% for composition B and 9.9% for composition A at 23° C.) and even greater than 2% at 40° C. (2.2% for composition B and 50.9% for composition A).

Compositions A and B advantageously exhibit a good compromise of structural properties and flexibility, over a wide temperature range (23° C., 40° C.).

1-17. (canceled)

18. A composition comprising:
an —NCO component comprising:
A. at least one polyurethane having at least two NCO end groups; and
B. optionally a polyisocyanate compound comprising at least one polyisocyanate P comprising at least three isocyanate functions NCO; and
an —OH component comprising:
a polybutadiene polyol P1 comprising at least two hydroxyl functions, said polyol P1 having a number-average molecular weight ranging from 1000 g/mol to 15,000 g/mol;
a polyol P2 chosen from diols, triols, or mixtures thereof, said polyol P2 having a number-average molecular weight or number-average molar mass ranging from 60 to 500 g/mol;
a polyol P3 having a hydroxyl functionality of greater than or equal to 2, said polyol P3 being selected from the group consisting of polyether polyols, polyols of natural origin, polyester polyols, and mixtures thereof, said polyol P3 having a number-average molecular weight ranging from 800 to 5000 g/mol; and
at least one filler, the total content of filler(s) being greater than or equal to 30% by weight relative to the total weight of said-OH component.

19. The composition as claimed in claim 18, characterized in that the polyurethane A) is obtained from:
a composition comprising at least one polyoxyalkylene polyol, the saturated, linear or branched alkylene part of which comprises from 2 to 4 carbon atoms, and
a composition comprising at least polymeric MDI.

20. The composition as claimed in claim 18, characterized in that the —NCO component comprises a polyisocyanate compound B), said polyisocyanate compound B) being a polyisocyanate mixture comprising at least one polyisocyanate P comprising at least three NCO functions.

21. The composition as claimed in claim 18, characterized in that the —NCO component comprises a polyisocyanate compound B), said polyisocyanate compound B) being a mixture comprising:
at least one MDI monomer; and
at least one polyisocyanate P having the following formula: 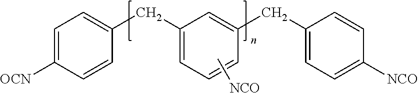
wherein n can vary from 1 to 8.

22. The composition as claimed in claim 18, characterized in that the —NCO component comprises more than 50% by weight, of polyurethane A), relative to the total weight of said —NCO component.

23. The composition as claimed in claim 18, characterized in that the —NCO component comprises:
from 1% to 40% by weight, of polyurethane(s) A); and
from 50% to 90% by weight, of polyisocyanate compound(s) B).

24. The composition as claimed in claim 18, characterized in that the —NCO component comprises at least one additive selected from the group consisting of plasticizers, catalysts, solvents, pigments, adhesion promoters, moisture absorbers, UV stabilizers (or antioxidants), dyes, rheological agents, and mixtures thereof.

25. The composition as claimed in claim 18, characterized in that the —NCO component comprises from 0% to 10% by weight, of hollow glass microspheres, relative to the total weight of said —NCO component.

26. The composition as claimed in claim 18, characterized in that the total content of polyol(s) P1 ranges from 1% to 30% by weight, relative to the total weight of the —OH component.

27. The composition as claimed in claim 18, characterized in that the diol P2 is selected from the group consisting of ethylene glycol, diethylene glycol, propylene glycol, dipropylene glycol, propane-1,3-diol, butane-1,4-diol, neopentyl glycol, 2-methylpropane-1,3-diol, hexane-1,6-diol, 2-ethylhexane-1,3-diol, and mixtures thereof.

28. The composition as claimed in claim 18, characterized in that the number-average molecular weight of the polyol P3 ranges from 800 g/mol to 2500 g/mol.

29. The composition as claimed in claim 18, characterized in that the polyol P3 is chosen from polyether triols and derivatives of polyols of natural origin.

30. The composition as claimed in claim 18, characterized in that the total content of polyol(s) P3 ranges from 5% to 40% by weight, relative to the total weight of the —OH component.

31. The composition as claimed in claim 18, characterized in that the —OH component comprises a total amount of filler(s) of greater than or equal to 40% by weight, relative to the total weight of the —OH component.

32. The composition as claimed in claim 18, characterized in that the —OH component comprises:
at least one carbonate filler; and
from 0% to 10% by weight of hollow glass microspheres relative to the total weight of said —OH component.

33. The composition as claimed in claim 18, characterized in that the volume ratio of —OH component/—NCO component, within the composition, ranges from 1/3 to 3/1.

34. An adhesive, sealant, or coating comprising the composition as defined in claim 18.
